(19) United States
(12) Patent Application Publication
(10) Pub. No.: US 2006/0125835 A1
(43) Pub. Date: Jun. 15, 2006

(54) DMA latency compensation with scaling line buffer

(76) Inventors: Li Sha, San Jose, CA (US); Qifan Huang, Sunnyvale, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/090,465

(22) Filed: Mar. 25, 2005

Related U.S. Application Data
(60) Provisional application No. 60/635,114, filed on Dec. 10, 2004.

(51) Int. Cl. G09G 5/36

(52) U.S. Cl. 345/560

(57) ABSTRACT

A video processing system configured with DMA latency compensation is disclosed. This compensation helps minimize or otherwise mitigate shortages of data to the display, thereby improving the quality of displayed video. A relatively small line buffer is used to stage data for video processing. Should an underflow of data occur (where the buffer reading process is ahead of the buffer writing process), data is read from the previous line buffer. This not only prevents shortages of data to the display, but also provides data that is more likely to be relevant to the actual scene being displayed (as compared to random data).

### RELATED APPLICATIONS

This application claims the benefit of U.S. Provisional Application No. 60/635,114, filed on Dec. 10, 2004. In addition, this application is related to U.S. application Ser. No. 10/966,058, filed Oct. 14, 2004, and titled “System and Method for Rapidly Scaling and Filtering Video Data”, which claims the benefit of 60/568,892, filed on May 7, 2004. Each of these applications is herein incorporated in its entirety by reference.

### FIELD OF THE INVENTION

The invention relates to video processing, and more particularly, to video display scan out with direct memory access (DMA) compensation.

### BACKGROUND OF THE INVENTION

Conventional video processing systems use a frame buffer to store received video data, so that data can be processed prior to being sent to the display. A direct memory access (DMA) controller is typically used to facilitate fast acquisition of the data from the frame buffer and to limit system processor involvement. The retrieved video data can then be provided to the video processing components of the system, such as horizontal and vertical scaling, as well as filtering. Once fully processed, the video scan output is provided to the display.

One problem associated with conventional video processing systems is that the video scan out is at a constant rate. However, the latency of the DMA is variable. This variable latency gives rise to a number of problems. For instance, when the video processing system is busy, the DMA latency tends to be very large. As such, the display will likely suffer a shortage of data.

Conventional techniques for eliminating this DMA latency include the use of a large buffer that is generally divided into two portions. One portion of this large buffer is designated as workspace that supplies the video processing circuitry with a steady stream of buffered data. The other portion of the buffer is for staging the next large block of data to be processed. Thus, while video data in the workspace of the buffer is being processed, the staging space of the buffer is being loaded. Latency due to an underflow of data is therefore reduced.

However, such conventional techniques are associated with a number of problems. For instance, large buffers occupy a relatively large physical space. Such space comes at a premium in many applications, particularly those involving system-on-chip (SOC) designs. Also, despite the use of a very large buffer, it is still possible that an underflow condition will arise. In such a case, the data that is actually read out of the buffer is purely random and has no basis in the imaged scene. Thus, the viewer is more likely to detect flaws in the displayed video.

What is needed, therefore, are DMA latency compensation techniques that help minimize shortages of data to the display.

### SUMMARY OF THE INVENTION

One embodiment of the present invention provides a video processing system. The system includes a direct memory access (DMA) engine configured to facilitate the transfer of video data from a storage to processing sections of the system, and a line buffer module that is configured to mitigate shortages of data available for display caused by latency associated with data transfers performed by the DMA engine. This mitigation is achieved by reading out video data from a corresponding position in a previous line in the line buffer module when a current line is in an underflow condition. In one particular configuration, the line buffer module is further adapted to determine if an underflow condition exists by maintaining a write pointer and a read pointer for each line of the line buffer module. Here, an underflow condition exists if the read pointer is greater than (or otherwise ahead of) the write pointer. Note that the corresponding position in the previous line can be determined by the read pointer.

The video processing system may include other features as well. For instance, the system may include a display for displaying scaled and filtered video data produced by the system. The system may include the storage from which the DMA engine transfers video data to processing sections of the system. In one such case, the storage is a frame buffer for storing a frame of video data. The system of claim may further include a logical scaling and filtering module that is configured to perform vertical and horizontal scaling and filtering on the video data. The system can be implemented as a system-on-chip design, although other implementations (e.g., chip sets or printed wiring board) can be realized as well.

In one particular embodiment, the line buffer module includes a line buffer, a write agent, and a read agent. The line buffer has a number of lines (including the current line and the previous line). Each of the lines is for storing a line of video data. The write agent is adapted to receive video data from the DMA engine, and to write that video data into one or more lines of the line buffer. The read agent is adapted to read out video data from a corresponding position in the previous line in the line buffer when the current line is in an underflow condition. In one such configuration, the write agent maintains a write pointer for each line of the line buffer and the read agent maintains a read pointer for each line of the line buffer, and an underflow condition is determined by comparing the read and write pointers for a given line. In another such configuration, the write agent is further configured to set a line flag for each line of the line buffer so as to indicate that line is ready to be read by the read agent, and the read agent is further configured to clear a line flag for each line of the line buffer so as to indicate that line is available to be written new data by the write agent. Note that the use of “set” and “clear” are not intended to implicate any particular state (such as logical high or logical low). The line buffer module may further include one or more accumulator units configured to perform multiplying and accumulating of video data read out from the line buffer (e.g., for subsequent processing or use).

Another embodiment of the present invention provides a line buffer module configured to mitigate shortages of data available for display in a video processing system caused by latency associated with direct memory access (DMA) data transfers. The system includes a line buffer having a number of lines including a current line and a previous line. Each of the lines is for storing a line of video data. A write agent is adapted to receive video data from a DMA engine, and to write that video data into one or more lines of the line buffer. A read agent is adapted to read out video data from a corresponding position in the previous line in the line buffer when the current line is in an underflow condition, thereby mitigating shortages of data available for display caused by the latency associated with the DMA data transfers. The write and read agents can be configured to maintain pointers and flags as previously described, so as to facilitate the reading and writing processes. Note that the read agent and the write agent can be implemented using gate level logic, although software or firmware could also be used here, depending on factors such as available design space, manufacturing complexity, and per unit cost. One or more accumulator units may be included that are configured to perform multiplying and accumulating of video data read out from the line buffer. In one particular case, the previous line is the line immediately before the current line in the line buffer.

Another embodiment of the present invention provides a method for mitigating shortages of data available for display in a video processing system caused by latency associated with direct memory access (DMA) data transfers. The method includes receiving video data from a DMA engine, and writing the received video data into one or more lines of a line buffer, including a previous line and a current line. The method continues with reading out video data from a corresponding position in the previous line in the line buffer when the current line is in an underflow condition, thereby mitigating shortages of data available for display caused by the latency associated with the DMA data transfers. The method may include maintaining a write pointer for each line of the line buffer, maintaining a read pointer for each line of the line buffer, and comparing the read and write pointers for a given line to determine if an underflow condition exists. The method may include indicating when a line of video data is ready to be read, and indicating when a line of the line buffer is available to be written new data. The method may include multiplying and accumulating video data read out from the line buffer.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram of a video processing system configured in accordance with one embodiment of the present invention.

FIG. 2a is a block diagram of a video processing system line buffer configured with DMA latency compensation in accordance with one embodiment of the present invention.

FIG. 2b illustrates the line buffer of FIG. 2a in an underflow condition, necessitating a read from the previous line buffer in accordance with one embodiment of the present invention.

FIG. 3a is a flow chart illustrating a method for writing video data to a line buffer configured with DMA latency compensation in accordance with one embodiment of the present invention.

FIG. 3b is a flow chart illustrating a method for reading video data from a line buffer configured with DMA latency compensation in accordance with one embodiment of the present invention.

### DETAILED DESCRIPTION OF THE INVENTION

A video processing system configured with DMA latency compensation is provided. This compensation helps minimize or otherwise mitigate shortages of data to the display, thereby improving the quality of displayed video. A relatively small line buffer is used to stage data for video processing. Should an underflow of data occur (where the buffer reading process is ahead of the buffer writing process), data is read from the previous line buffer. This not only prevents shortages of data to the display, but also provides data that is more likely to be relevant to the actual scene being displayed (as compared to random data).

System Architecture

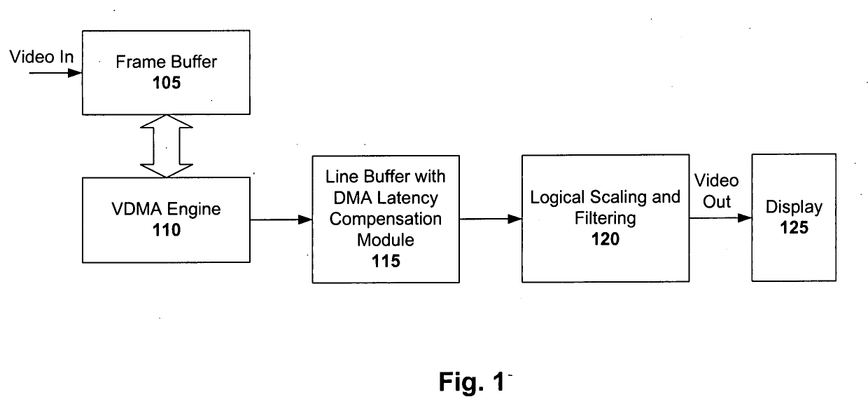

FIG. 1 is a block diagram of a video processing system configured in accordance with one embodiment of the present invention. The system includes a frame buffer 105, a virtual direct memory access (VDMA) engine 110, a line buffer with DMA latency compensation module 115, a logical scaling and filtering module 120, and a video display 125. Other components and features not shown may also be included in the system, such as various processors, front end processing circuitry, registers, format unification modules, noise filters, motion estimation and compensation modules, and output interface circuitry.

Data is provided to the video input of the frame buffer 105, and can be in a number of data formats (e.g., YUV or RGB). The buffer 105 can be implemented with conventional or custom technology, and its size and structure will vary depending on the particular application. The buffer 105 generally refers to a storage mechanism whether on an integrated circuit or a defined portion of memory where frame data is stored. Recall that a frame refers to a single image in a digital video stream. Many digital video streams have 30 frames per second or 30 individual images that make up one second of video.

The VDMA engine 110 can be implemented in conventional technology, and is configured to facilitate the transfer of video data from the frame buffer 105 to the logical scaling and filtering module 120 via the line buffer module 115. Use of the VDMA engine 110 allows the data transfer to take place without necessarily utilizing processing resources of the system.

In one particular embodiment, the VDMA engine 110 is configured with a number (e.g., two, eight, or thirty-two) of DMA channels used to transfer the retrieved video data to the line buffer module 115. The number of DMA channels will depend on factors such as the buffer size and the desired video processing speed. Each channel can be associated with configuration registers for holding information, such as the start address of data, the end address of data, the length of data transferred, type of stop transfer mechanism, and the source address of the data. Alternatively, the VDMA engine 110 may facilitate the transfer of data from frame buffer 105 to line buffer module 115 using a bus structure or a shared bus structure. Other data transfer mechanisms can be used here as well, and the present invention is not intended to be limited to any one such configuration.

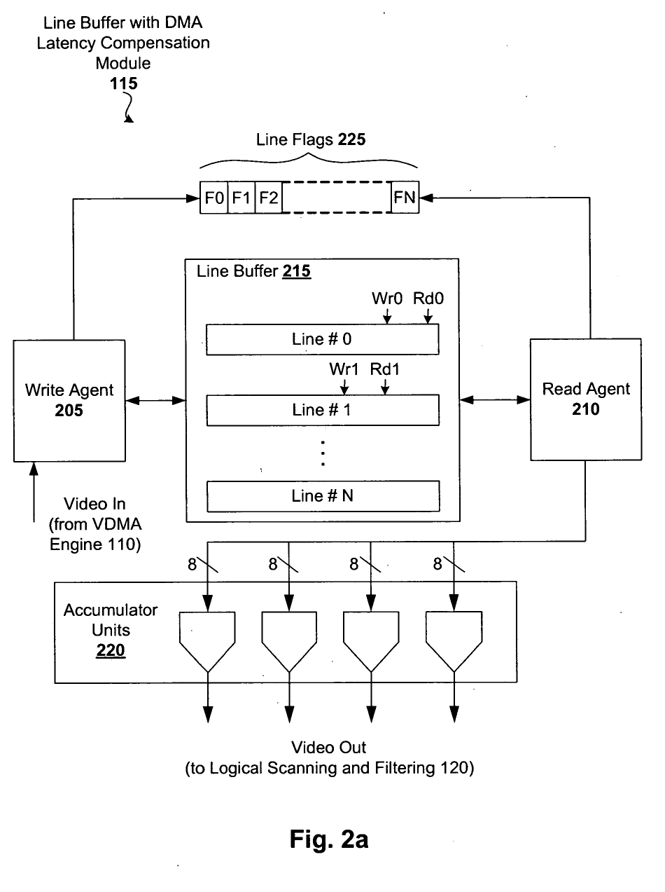

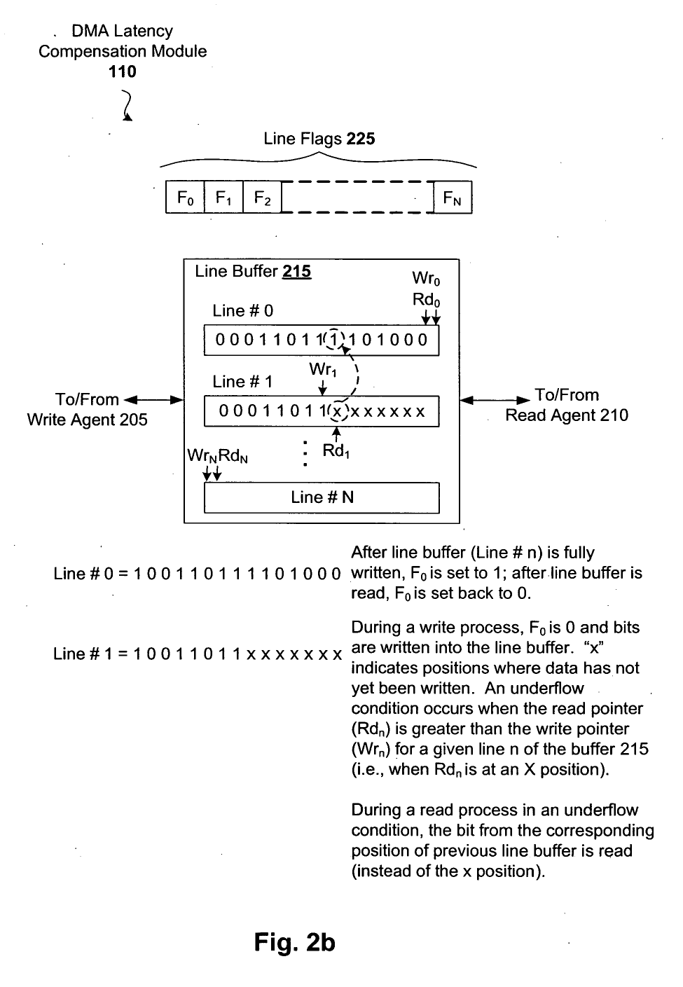

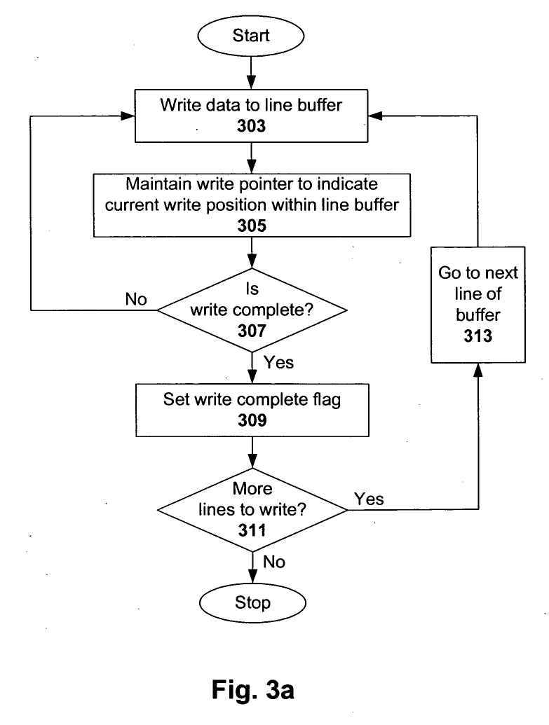

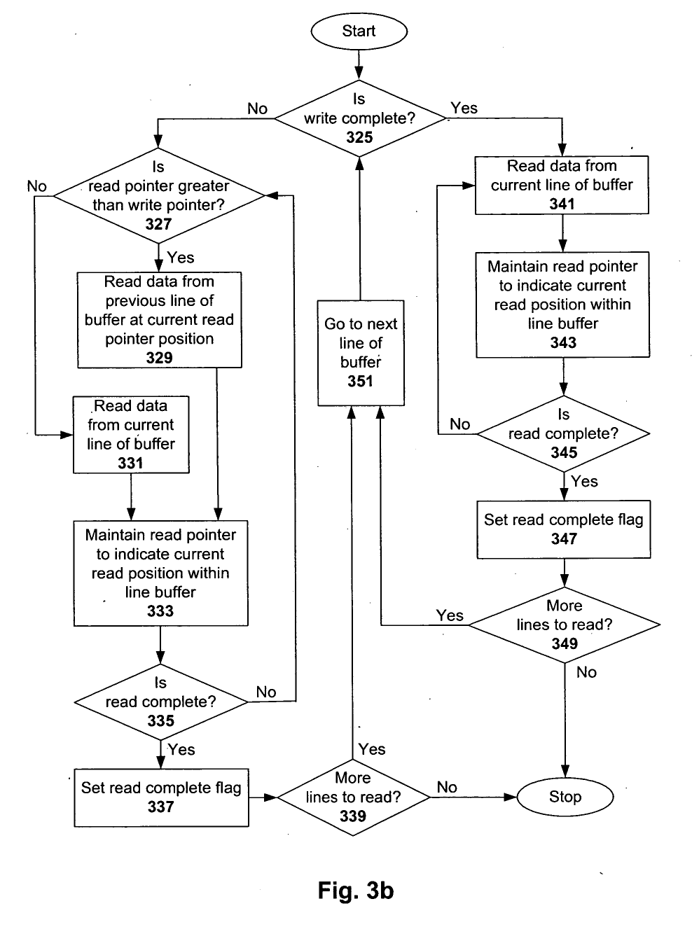

The line buffer with DMA latency compensation module 115 is configured to eliminate or otherwise mitigate shortages of data to the logical scaling and filtering module 120, and ultimately to the display 125. Such shortages would typically be caused by latency associated with data transfers performed by the VDMA engine 110, particularly when the system is processing a large amount of video data. The architecture and functionality of the line buffer module 115 will be discussed in further detail with reference to FIGS. 2a, 2b, 3a, and 3b.

The logical scaling and filtering module 120 can be implemented with conventional or custom technology, and is configured to perform the necessary vertical and horizontal scaling on the received video data, as well as the necessary filtering associated with each process. In one particular embodiment, the logical scaling and filtering module 120 is configured as described in the previously incorporated U.S. application Ser. No. 10/966,058, filed Oct. 14, 2004, titled “System and Method for Rapidly Scaling and Filtering Video Data.”

Scale or scaling generally refers to the process of changing the resolution of an image or making an image or video frame larger or smaller than its original resolution. For instance, converting a video from NTSC (640×480) resolution to HDTV (1920×1080) resolution is one example of “scaling” the video or more specifically, up-scaling. An example of downscaling would be converting from HDTV to NTSC. Filtering refers to a set of coefficients and a way of applying those coefficients to the original pixels in a video frame in order to create a new modified video frame. Numerous scaling and filtering techniques, as well as the underlying architectures, can be used here, as will be apparent in light of this disclosure.

The display 125 can be, for example, a high-definition television (HDTV) or a flat panel display or a cathode ray tube (CRT). Note that the video processing system can be configured in accordance with the resolution of the display 125. Recall that resolution refers to the number of pixels in the rows and columns of an image to be displayed. For instance, it may be said that the resolution of a HDTV frame is 1920×1080 pixels, meaning that there are 1920 columns of pixels and 1080 rows of pixels in a single frame of an HDTV video.

Further note that the framer buffer 105 can be configured to store the data from one frame, and that the line buffer module 115 can be configured to store a number of lines from that frame at any given time. A line of video data generally refers to a single row of image pixels from a single frame of a video. Note, however, that a line a data can be stored and processed in portions, as opposed to storing and processing a whole line of video data.

Line Buffer with Latency Compensation

FIG. 2a is a block diagram of a line buffer configured with DMA latency compensation in accordance with one embodiment of the present invention. In this example configuration, the module 115 includes a write agent 205, a read agent 210, a line buffer 215, four 8-bit accumulator units 220, and a line flags register 225. Video data retrieved by the VDMA engine 110 is received by the write agent 205, and the video output of the accumulator units 220 is provided to the logical scaling and filtering module 120.

As can be seen, the line buffer 215 is organized into N lines. In one particular embodiment, there are four options for N: N=5, where the input image horizontal size is <=1920, and the stride is 1920/4=480; or N=7, where the input image horizontal size is <=1368, and the stride is 1360/4=340; or N=9, where the input image horizontal size is <=1064, and the stride is 1064/4=266; or N=13, where the input image horizontal size is <=736, and the stride is 736/4=184. Other image sizes and strides can be used here as well, and the present invention is not intended to be limited to any one such buffer 215 configuration.

The write agent 205 is configured to maintain a write pointer for each line in the buffer 215, and the read agent 210 is configured to maintain a read pointer for each line in the buffer 215. For instance, the write pointer for line # 0 is Wr₀, and the write pointer for line # 1 is Wr₁. Likewise, the read pointer for line # 0 is Rd₀, and the read pointer for line # 1 is Rd₁.

When the write agent 205 finishes writing a line of the buffer 215, the write agent 205 sets a flag Fₙ (e.g., to logical one). When the read agent 210 starts the last read to line x, the read agent 210 clears the Fₓ flag (e.g., to logical zero). This enables the write agent 205 to start writing into this line. In one particular embodiment, the read agent 210 is configured to read out a word of data for each read. The data word includes four continuous pixels (8-bits each in this example) in the same line for Y/A/R/G/B. For UV, the data word includes two U data and two V data (each U and V are 8-bits in this example). The accumulator units 220 are configured to perform multiplying and accumulating for filter processing, as necessary.

Note that the variables n and x are integers somewhere between 0 and N (inclusive), where x may be less than n, equal to n, or greater than n. If x is less than n, then no underflow condition will occur when line x is read. If x is equal to n, then an underflow condition may occur if the read operation gets ahead of the write operation for that line n (e.g., due to DMA latency). If x is greater than n, then there is an underflow condition.

The read agent 210 is supposed to read data out of the line buffer 215 at a constant rate. If at any given moment, however, the VDMA engine 110 cannot catch up the output rate, the line buffer 215 will underflow. When such an underflow condition occurs, the read agent 210 is configured to use the data of the previous line in the buffer 215 as replacement data. If the VDMA engine 110 can catch up during one line time, this mitigating data replacement may not be noticeable by the user viewing the display 125.

Using data from a previous image line is effective replacement data, because neighboring image lines of the buffer 215 are very similar with each other, given a natural scene. This is why the viewer will likely be unaware of the data replacement. In addition, note that this technique effectively provides a one line buffer size increase (e.g., 1920×8×2 bytes of memory per frame).

Note that the line buffer 215 and line flags register 225 and accumulator units 220 can be implemented in conventional or custom technology, as will be apparent in light of this disclosure. The write agent 205 and the read agent 210 can be implemented, for example, with field programmable gate array or purpose built logic, such as an application specific integrated circuit (ASIC). In one particular embodiment, the entire video processing system of FIG. 1, including the line buffer with DMA compensation module 115, is implemented on a single ASIC, so as to provide a system-on-chip (SOC). Other configurations can also be realized, including those that include chip sets or printed circuit board level designs.

FIG. 2b illustrates the line buffer 215 of FIG. 2a in an underflow condition, necessitating a read from the previous line of buffer 215 in accordance with one embodiment of the present invention. Assume the following: N=5, input image horizontal size is <=1920, and the stride is 1920/4=480.

In this example, line buffer #0 is fully written and fully read, as indicated by the respective write and read pointers, Wr₀ and Rd₀(both pointers are at the far right data position of line buffer #0). As previously explained, F₀ of the line flags 225 is set (e.g., logical one) by the write agent 205 once the write to line buffer #0 is complete. The completion of a write operation can be determined, for example, by comparing the value of write pointer Wr₀ to the known horizontal size of the line buffer. For instance, if the horizontal buffer size is 32 bits, then a write operation would be complete when the value of the write pointer Wr₀ is 32.

No Underflow Condition

With the line flag F₀ set, the read agent 210 knows that the buffer line #0 is fully written and ready for a read operation. Note that in cases where the write operation is fully completed prior to initiation of the read operation, there will be no underflow condition for that line. F₀ of the line flags 225 is cleared (e.g., logical zero) by the read agent 210 once the read from line buffer #0 is complete. The completion of a read operation can be determined, for example, by comparing the value of read pointer Rd₀ to the known horizontal size of the line buffer. For instance, if the horizontal buffer size is 32 bits, then a read operation would be complete when the value of the read pointer Rd₀ is 32.

Note that each of the example write and read operation assumes that bits are written to or read from each line from left to right. Other read schemes can be used here as well, whether implemented in hardware logic, software, or a combination hardware and software.

Underflow Condition

The next line of buffer 215 is line buffer #1. Here, note that the read pointer Rd₁ is greater than (or otherwise ahead of) the write pointer Wr₁. This situation is referred to herein as an underflow condition. The read agent is configured to be aware for the potential for underflow conditions, because when the read agent 210 goes to read the line buffer #1, the read agent 210 will see that F₁ of the line flags 225 is not set (e.g., logical one), thereby indicating that the write operation to line buffer #1 is in process or otherwise incomplete.

In this case, the read agent 210 compares or otherwise interrogates the read and write pointers, Rd₁ and Wr₁. If the read agent 210 determines that the read pointer Rd₁ is less than (or otherwise behind) the write pointer Wr₁, then data from line buffer #1 is read as normally done for each bit position. If, on the other hand, the read agent 210 determines that the read pointer Rd₁ is equal to or greater than (or otherwise ahead of) the write pointer Wr₁, then line buffer #1 is in an underflow condition, and mitigating action is taken by the read agent 210.

In particular, the read agent 210 retrieves that data from line buffer #0 at the position indicated by the read pointer Rd₁. In the example shown, “x” is used to indicate positions in the line buffer #1 where data has not yet been written. The first x that occurs in line buffer #1 is a bit position nine (i.e., Rd₁=9 or binary 1001). Thus, the read agent 210 is configured to read bit position nine of line buffer #0, which in this example is a logical one. This latency mitigation process will continue until the read pointer Rd₁ is behind the write pointer Wr₁.

Note that if the underflow condition persists, then other action may be taken. For example, there may be a functional problem with the video processing system, and a warning or maintenance message could be displayed to the user. Alternatively, the read agent 210 could be configured to institute a predetermined delay in the read process if two consecutive lines of buffer 215 exhibit underflow conditions. Such a predetermined delay could be optimized to be a little as possible (e.g., based on degree of underflow), so as to minimize the shortage of data (if any) to the display 125.

Further note that use of the terms “greater than” and “less than” herein are not intended to implicate any rigid directional structure for the read and write operations performed by the line buffer with DMA compensation module 115. Rather, the terms are used to indicate the temporal relationship between the read and write processes. If the read process is ahead of the corresponding write process for a given line of buffer 215, then the read pointer associated with that read process is greater than the corresponding write pointer. If the read process is behind the corresponding write process for a given line of buffer 215, then the read pointer associated with that read process is less than the corresponding write pointer.

Methodology

FIG. 3a is a flow chart illustrating a method for writing video data to a line buffer configured with DMA latency compensation in accordance with one embodiment of the present invention. This method can be carried out, for example, by the write agent 205 of FIG. 2a.

The method begins with writing 303 video data to a line buffer. The data can be provided, for instance, by operation of a VDMA engine accessing a frame buffer that stores frames of the video data. The method continues with maintaining 305 a write pointer to indicate a current write position within the line buffer. In one embodiment, the write pointer is initialized to one for the first bit position of the line buffer, and is incremented for each subsequent bit position of that line buffer until the last position within that line is written. Variations will be apparent in light of this disclosure. For instance, the write process may write entire words at a time (as opposed to individual bits), where the pointer is incremented for each data word. Any data segment can be used here.

The method continues with determining 307 whether or not the write is complete for a given line of the buffer. As previously explained, this determination can be carried out, for example, by comparing the write flag to a known length of the line buffer. Alternatively, the number of writes can simply be tallied, with the Nth write indicating the last write as well as the end of the line buffer. In any case, if the write is not complete, the method continues with writing 303 the next video data to the line buffer and maintaining 305 the write pointer until the determination 307 indicates the write is complete.

In response to the determination 307 indicating the write is complete, the method continues with setting 309 a write flag. This flag is used to indicate that the line is fully written and available for reading out for subsequent processing and display. The method proceeds with determining 311 if there are more lines to write. If so, the method continues with going 313 to the next line, and the write process (303 through 313) is repeated. If there are no more lines of video data to write to the buffer, then the method concludes, and waits for the next frame of data.

FIG. 3b is a flow chart illustrating a method for reading video data from a line buffer configured with DMA latency compensation in accordance with one embodiment of the present invention. This method can be carried out, for example, by the read agent 210 of FIG. 2a.

The method begins with determining 325 if the write operation for the current line of the line buffer is complete. If the write operation is complete, then no underflow condition exists for that particular line buffer. In this case, the method continues with reading 341 data from the current line of the buffer, and maintaining 343 a read pointer to indicate the current read position within that line. In one embodiment, the read pointer is initialized to one for the first bit position of the line buffer, and is incremented for each subsequent bit position of that line buffer until the last position within that line is read. Variations will be apparent in light of this disclosure. For instance, the read process may read entire words at a time (as opposed to individual bits), where the pointer is incremented for each data word. Just as with the write process, any size data segment can be used here. The method continues with determining 345 whether or not the read is complete for the current line of the buffer. As previously explained, this determination can be carried out, for example, by comparing the read flag to a known length of the line buffer. Alternatively, the number of reads can simply be tallied, with the Nth read indicating the last read as well as the end of the line buffer. In any case, if the read is not complete, the method continues with reading 341 the next video data from the current line buffer and maintaining 343 the read pointer until the determination 345 indicates the read is complete. In response to the determination 345 indicating the read is complete, the method continues with setting 347 a read flag. This flag is used to indicate that the line is fully read and available for writing of data. The method proceeds with determining 349 if there are more lines to read. If so, the method continues with going 351 to the next line of the buffer, and the read process (325, and 341 through 351 or 325, 327 through 339, and 351) is repeated. If there are no more lines of video data to read from the buffer, then the method concludes, and waits for the next round of video data processing. Note that if the line is completely written (e.g., as indicated by a write flag) and no underflow condition exists for a given line, the maintaining 343 a read pointer to indicate the current read position within that line can be made optional (assuming the completion of a read process can still be detected).

If, on the other hand, the determination 325 indicates that the write operation is not complete, then an underflow condition may exist for that particular line buffer. In this case, the method continues with determining 327 if the read pointer is greater than (or equal to) the write pointer. This determination as well as pointer maintenance can be carried out, for example, using gate level logic (e.g., FPGA or ASIC). Alternatively, a digital signal processor (DSP) or other suitable processing environment can be programmed or otherwise configured to maintain the pointers and to determine whether the read or write pointers is ahead.

In any case, if the determination 327 indicates that the read pointer is greater than (or equal to) the write pointer, then the method proceeds with reading 329 data from previous line of the buffer at the current read pointer position. As previously discussed, this data is likely to be very similar to the missing data of the current line buffer. If, on the other hand, the determination 327 indicates that the read pointer is less than the write pointer (indicating no underflow), then the method proceeds with reading 329 data from the current line of the buffer at the current read pointer position.

Regardless of whether the current or previous line of the buffer is read, the method continues with maintaining 333 a read pointer to indicate the current read position within line buffer. The previous discussion as to the pointer maintenance (e.g., initialization, incrementing, and data segment size) is equally applicable here. The method further continues with determining 335 if the read is complete, as previously discussed with reference to 345.

If the read is not complete, the method repeats determination 329 and the subsequent processing (329 or 331, and 333 through 335) until the determination 335 indicates the read is complete. In response to the determination 335 indicating the read is complete, the method continues with setting 337 a read flag. As previously explained, this flag is used to indicate that the line is fully read and available for writing of data. The method proceeds with determining 339 if there are more lines to read. If so, the method continues with going 351 to the next line of the buffer, and the read process (325, and 341 through 351 or 325, 327 through 339, and 351) is repeated. If there are no more lines of video data to read from the buffer, then the method concludes, and waits for the next frame of data.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A video processing system, comprising:
a direct memory access (DMA) engine configured to facilitate transfer of video data from a storage to processing sections of the system; and
a line buffer module configured to mitigate shortages of data available for display caused by latency associated with data transfers performed by the DMA engine, by reading out video data from a corresponding position in a previous line in the line buffer module when a current line is in an underflow condition.

2. The video processing system of claim 1 further comprising:
a display for displaying scaled and filtered video data produced by the system.

3. The video processing system of claim 1 further comprising the storage from which the DMA engine transfers video data to processing sections of the system, wherein the storage is a frame buffer for storing a frame of video data.

4. The video processing system of claim 1 further comprising:
a logical scaling and filtering module configured to perform vertical and horizontal scaling and filtering on the video data.

5. The video processing system of claim 1 wherein the line buffer module further comprises:
a line buffer having a number of lines including the current line and the previous line, each of the lines for storing a line of video data;
a write agent adapted to receive video data from the DMA engine, and to write that video data into one or more lines of the line buffer; and
a read agent adapted to read out video data from a corresponding position in the previous line in the line buffer when the current line is in an underflow condition.

6. The video processing system of claim 5 wherein the write agent maintains a write pointer for each line of the line buffer and the read agent maintains a read pointer for each line of the line buffer, and an underflow condition is determined by comparing the read and write pointers for a given line.

7. The video processing system of claim 5 wherein the write agent is further configured to set a line flag for each line of the line buffer so as to indicate that line is ready to be read by the read agent, and the read agent is further configured to clear a line flag for each line of the line buffer so as to indicate that line is available to be written new data by the write agent.

8. The video processing system of claim 5 wherein the line buffer module further comprises:
one or more accumulator units configured to perform multiplying and accumulating of video data read out from the line buffer.

9. The video processing system of claim 1 wherein the line buffer module is further adapted to determine if an underflow condition exists by maintaining a write pointer and a read pointer for each line of the line buffer module, wherein an underflow condition exists if the read pointer is ahead of the write pointer, and the corresponding position in the previous line is determined by the read pointer.

10. The video processing system of claim 1 wherein the system is implemented as a system-on-chip design.

11. A line buffer module configured to mitigate shortages of data available for display in a video processing system caused by latency associated with direct memory access (DMA) data transfers, comprising:
a line buffer having a number of lines including a current line and a previous line, each of the lines for storing a line of video data;
a write agent adapted to receive video data from a DMA engine, and to write that video data into one or more lines of the line buffer; and
a read agent adapted to read out video data from a corresponding position in the previous line in the line buffer when the current line is in an underflow condition, thereby mitigating shortages of data available for display caused by the latency associated with the DMA data transfers.

12. The line buffer module of claim 11 wherein the write agent maintains a write pointer for each line of the line buffer and the read agent maintains a read pointer for each line of the line buffer, and an underflow condition is determined by comparing the read and write pointers for a given line.

13. The line buffer module of claim 11 wherein the write agent is further configured to set a line flag for each line of the line buffer so as to indicate that line is ready to be read by the read agent, and the read agent is further configured to clear a line flag for each line of the line buffer so as to indicate that line is available to be written new data by the write agent.

14. The line buffer module of claim 11 further comprising:
one or more accumulator units configured to perform multiplying and accumulating of video data read out from the line buffer.

15. The line buffer module of claim 11 wherein the read agent and the write agent are implemented using gate level logic.

16. The line buffer module of claim 11 wherein the previous line is the line immediately before the current line in the line buffer.

17. A method for mitigating shortages of data available for display in a video processing system caused by latency associated with direct memory access (DMA) data transfers, comprising:
receiving video data from a DMA engine;
writing the received video data into one or more lines of a line buffer, including a previous line and a current line; and
reading out video data from a corresponding position in the previous line in the line buffer when the current line is in an underflow condition, thereby mitigating shortages of data available for display caused by the latency associated with the DMA data transfers.

18. The method of claim 17 further comprising:
maintaining a write pointer for each line of the line buffer;
maintaining a read pointer for each line of the line buffer; and
comparing the read and write pointers for a given line to determine if an underflow condition exists.

19. The method of claim 17 further comprising:
indicating when a line of video data is ready to be read; and
indicating when a line of the line buffer is available to be written new data.

20. The method of claim 17 further comprising:
multiplying and accumulating video data read out from the line buffer.
